(19) United States
(12) Patent Application Publication
(10) Pub. No.: US 2013/0185214 A1
(43) Pub. Date: Jul. 18, 2013

(54) System and Method For Secure Offline Payment Transactions Using A Portable Computing Device

(71) Applicants: Jon Azen, Atlanta, GA (US); Jose Menendez, San Diego, CA (US); Eric Kraar, Atlanta, GA (US); Gregory G. Rose, San Diego, CA (US)

(72) Inventors: Jon Azen, Atlanta, GA (US); Jose Menendez, San Diego, CA (US); Eric Kraar, Atlanta, GA (US); Gregory G. Rose, San Diego, CA (US)

(73) Assignee: Firethorn Mobile Inc., Atlanta, GA (US)

(21) Appl. No.: 13/363,592

(22) Filed: Feb. 1, 2012

Related U.S. Application Data
(60) Provisional application No. 61/585,714, filed on Jan. 12, 2012.

(51) Int. Cl. G06Q 20/20; G06Q 20/32

(52) U.S. Cl. 705/76; 705/77; 705/78

(57) ABSTRACT

Disclosed is a system and method that provides a merchant associated with a point of sale (“POS”) system and a consumer associated with a portable computing device (“PCD”) to complete a purchase transaction without transmitting or presenting confidential payment credentials. In an exemplary embodiment, sound is used to transmit data between the POS and the PCD. A payment request is rendered on the PCD. The consumer reviews and authorizes via a unique cryptographic signature. The merchant approves via addition of its unique cryptographic signature. A remote service in communication with the POS verifies the signatures via previously registered public keys. The transaction is then settled to a consumer account. Confirmation is returned to the POS and PCD. Advantageously, the transaction is commenced and completed without the PCD being online. Further, the consumer payment credentials are not stored on the PCD or transmitted from the PCD to the merchant POS system.

### CROSS-REFERENCE TO RELATED APPLICATIONS

Priority under 35 U.S.C. §119(e) is claimed to the U.S. provisional application entitled “SYSTEM AND METHOD FOR SECURE OFFLINE PAYMENT TRANSACTIONS USING A PORTABLE COMPUTING DEVICE,” filed on Jan. 12, 2012 and assigned application Ser. No. 61/585,714, the entire contents of which are hereby incorporated by reference.

### DESCRIPTION OF THE RELATED ART

Noncash tender types are commonplace in today's society. Consumers routinely participate in transactions for purchasing goods and services by providing merchants with payment tokens which may be associated with any number of account types. “Credit card” tokens associated with secured or unsecured lines of credit and “gift card” or “debit card” tokens associated with stored value accounts are common examples of noncash tender used in today's marketplace.

The payment credentials represented by tokens are inherently confidential and must be safeguarded, lest the credentials be misappropriated by an unauthorized user. Even so, a user of a physical credit card token, for example, must freely hand over payment credentials to a merchant in order to complete a purchase transaction at a point of sale (“POS”). A common scenario exhibiting such an unsecured use of payment credentials is a consumer using a credit card to pay for a meal in a restaurant. In many such cases, the consumer reviews the bill and then actually hands his physical credit card token to a server, trusting that the payment credentials on the token will be safeguarded during and after the transaction.

Some payment systems and methodologies that make use of portable computing devices (“PCD”), such as smartphones, address the inherent insecurity of using a physical payment token at the point of sale. In these systems, the consumer and merchant are usually required to complete the transaction “in the cloud.” The merchant uses his POS system and the consumer uses his PCD to simultaneously authorize settlement of the transaction at a remote service. Some such methods require the consumer to render credentials at the POS and authorize settlement in the cloud, while other methods may conduct the entire transaction remotely. Notably, although such systems and methods do not necessarily require physical presentment of payment credentials, a disadvantage of all is that both the merchant and the consumer must be “online” to conduct the transaction. Moreover, some such systems and methods require the payment credentials to be stored on the PCD and/or digitally transmitted during the transaction process, thus potentially compromising the security of the credentials.

At the core of any system and method for settling transactions using payment credentials is the issue of authentication, i.e. proving that the consumer is authorized to use the payment credentials before the account associated with those credentials is debited. Current systems and methods can cause the confidentiality of payment credentials to be compromised, whether during authentication of the user of the credentials or during the actual process of settling a transaction. Further, current systems and methods for using PCDs to settle payment transactions at a POS require the PCD to be online during the transaction. Therefore, what is needed in the art is a system and method for conducting payment transactions offline with a PCD. Further, what is needed in the art is a system and method for conducting payment transactions offline with a PCD without requiring that payment credentials be stored on the PCD and/or transmitted from the PCD to a POS system.

### SUMMARY OF THE DISCLOSURE

Various embodiments of methods and systems for completing a purchase transaction using cryptographic authorizations shared between a consumer's portable computing device (“PCD”) and a merchant's point of sale (“POS”) system are described. According to embodiments, prior to conducting a purchase transaction both the consumer associated with a PCD and the merchant associated with a POS system will have completed a registration process with a remote service. To conduct a purchase transaction according to an exemplary embodiment, the consumer PCD and merchant POS system may be physically proximate in a storefront environment. Notably, however, it is envisioned that certain embodiments will not require the consumer PCD and merchant POS system to be physically proximate as purchase transactions may be conducted between them over a telecommunication or the like.

At the point of sale, the consumer PCD receives a payment request transmitted from a merchant POS system. The payment request may be tantamount to an invoice or the like for a good or service that the consumer wishes to purchase from the merchant associated with the POS system. The payment request may be transmitted wirelessly from the POS system to the PCD and, in some embodiments, is transmitted wirelessly using a series of audible tones. Accordingly, in such exemplary sound-based embodiments, the POS system and the PCD 110 are equipped with microphones and speakers that are configured to transmit and receive data via sound.

Upon receipt of the payment request at the PCD, the PCD may be operable to render the payment request for review by the consumer. After review, the consumer may approve the payment request by entering a personal identification number (“PIN”) which causes the PCD to digitally sign the payment request with a unique private key associated with the user. As is understood in the art of cryptography, the private key may serve to confirm the consumer's identity to a holder of the complimentary public key. The digital signature is transmitted back to the POS system where a digital signature associated with the merchant is also added, thus indicating the merchant's approval of the transaction. The payment request and the unique digital signatures are subsequently forwarded via a network connection from the merchant POS system to a remote service.

Upon receiving the digital signatures of the transacting parties (the merchant and the consumer) which indicate approval of the payment request, the remote service may use public keys previously uploaded to the service by the consumer and the merchant for use in verifying their respective identities. In some embodiments, the remote service may determine from the consumer's profile or data included within the signed payment request that a certain one of a plurality of accounts associated with the consumer should be debited in accordance with the payment request total. Further, it is envisioned that some embodiments of the system may include a means for selecting consumer accounts according to predefined rules or algorithms.

Once the identities of the parties have been confirmed, the remote service may query a database to identify a token that points to a previously registered consumer account. The service then leverages the token to settle the transaction to the identified consumer account by forwarding the token and payment request to a gateway/card processor. The gateway/card processor may then use the token to request payment credentials of the consumer from a vault service. Once the payment credentials are received from the vault service, the card processor may use the credentials to debit the associated account by the amount of the payment request, as is understood in the art of credit card processing. In some embodiments, a confirmation that the transaction has been settled to the consumer account is saved by the remote service and returned to the POS system. Subsequently, the POS system may generate a receipt and wirelessly transmit such to the PCD of the consumer.

Advantageously, a purchase transaction completed via the exemplary methods occurs without the consumer PCD being online or otherwise in communication with the remote service. That is, the data transmitted between the PCD and the POS system is exchanged wirelessly between the two components entirely within the storefront. Further, the purchase transaction is commenced and completed without consumer payment credentials being stored on the PCD or, for that matter, transmitted from the PCD to the merchant POS system.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral encompass all parts having the same reference numeral in all figures.

FIG. 1 is a high level diagram illustrating exemplary components of a system for completing a purchase transaction using cryptographic authorizations shared between a consumer's portable computing device (“PCD”) and a merchant's point of sale (“POS”) system;

FIG. 2 is a functional block diagram illustrating exemplary aspects of a PCD and a POS system that may be included in the FIG. 1 system;

FIG. 3 is a diagram of exemplary computer architecture for aspects of the system of FIG. 1;

FIG. 4 is a diagram of an exemplary, non-limiting aspect of a PCD comprising a wireless telephone which corresponds with FIG. 2;

FIG. 5 is a logical flowchart illustrating an exemplary method for registering, with a payment credential vault service, a consumer user of a system for completing a purchase transaction using cryptographic authorizations shared between a consumer's PCD and a merchant's POS system;

FIG. 6 is a logical flowchart illustrating an exemplary method for registering, with a third party payment service, a consumer user of a system for completing a purchase transaction using cryptographic authorizations shared between a consumer's PCD and a merchant's POS system;

FIG. 7 is a logical flowchart illustrating an exemplary method for registering the card network processor credentials of a merchant user of a system for completing a purchase transaction using cryptographic authorizations shared between a consumer's PCD and a merchant's POS system;

FIG. 8 is a logical flowchart illustrating an exemplary method for registering a third party payment service account of a merchant user of a system for completing a purchase transaction using cryptographic authorizations shared between a consumer's PCD and a merchant's POS system;

FIG. 9 is a logical flowchart illustrating an exemplary method for completing a purchase transaction through a card network processor using cryptographic authorizations shared between a consumer's PCD and a merchant's POS system; and

FIG. 10 is a logical flowchart illustrating an exemplary method for completing a purchase transaction through a third party payment service account using cryptographic authorizations shared between a consumer's PCD and a merchant's POS system.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the terms “application” and “app” may also include files having executable content, such as: object code, scripts, byte code, markup language files, and patches. In addition, an “application” or “app” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a module may be, but is not limited to being, a process running on a processor, a processor, an object, an executable, a thread of execution, a program, and/or a computer. By way of illustration, both an application running on a computing device and the computing device may be a module. One or more modules may reside within a process and/or thread of execution, and a module may be localized on one computer and/or distributed between two or more computers. In addition, these modules may execute from various computer readable media having various data structures stored thereon. The modules may communicate by way of local and/or remote processes such as in accordance with a signal having one or more data packets (e.g., data from one module interacting with another module in a local system, distributed system, and/or across a network such as the Internet or local WiFi with other systems by way of the signal).

In this description, the terms “mobile device” and “portable computing device” (“PCD”) is used to describe any device operating on a limited capacity power supply, such as a battery, and which does not have any active cooling devices, such as a fan. Although battery operated PCDs have been in use for decades, technological advances in rechargeable batteries coupled with the advent of third generation (“3G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop computer with a wireless connection, at tablet, among others.

Embodiments of the system and method described herein seek to provide a solution to the above described needs in the art, as well as other needs in the art, through secure digital signing at the point of sale (“POS”). At the heart of any system for paying by token is authentication—proving the token holder is who he says he is before giving him access to the resource represented by the payment credentials associated with the token. A corollary to authentication in a payment by token system is the desire to keep confidential the payment credentials, even while using them to complete a purchase transaction. Accordingly, embodiments of the systems and methods enable a consumer associated with certain payment credentials to complete a purchase transaction at a POS without transmitting, rendering or otherwise disclosing confidential payment credentials to the merchant or his POS system.

Exemplary embodiments enable consumers and merchants to conduct secure mobile payment transactions using audible or ultrasonic transmissions to transmit purchase and approval/authorization data between a consumer's PCD and a merchant's POS system without disclosing the consumer's payment credentials in the process. The consumer's PCD and the merchant's POS system are paired at the front end of the system so that the purchase transaction data and approval/authorization data can be exchanged between the parties before the transaction is ultimately settled by crediting the merchant's account and debiting the consumer's account in a backend system via secure channels inaccessible by the parties to the transaction.

Notably, although it is envisioned that some embodiments may use sound to exchange non-confidential data between a consumer PCD and a merchant POS, it is envisioned that other embodiments may use other protocols to share data between paired devices such as, but not limited to, near field communications (“NFC”), QR codes, etc. Even so, an advantage of embodiments that use sound to transmit data between a PCD and a POS system is the ease of integrating a solution into existing mobile payment systems because merchant and consumer mobile devices may already include the necessary hardware components (i.e., microphone and speaker).

Certain embodiments require both a consumer and a merchant to register online prior to conducting a payment transaction. Advantageously, once the merchant and consumer have completed the online registration process, it is not required that the consumer be online to complete a purchase transaction with the merchant because only authorization data is shared with the merchant's POS at the time of purchase. To initiate the payment transaction, a payment request is transmitted from the merchant POS system to the consumer PCD. A payment request may include, but is not limited to including, data indicative of a merchant ID, item descriptions, price totals, etc. Upon receiving the payment request, the consumer's PCD may render it for approval by the consumer. If the payment request is satisfactory, the consumer may digitally sign the payment request, thereby approving it, by entering a personal identification number (“PIN”) using the user interface of the PCD. Entry of the PIN causes the PCD to respond to the merchant POS system by transmitting an encrypted digital signature to serve as evidence of the consumer's authorization. Notably, the digital signature transmitted from the consumer PCD to the merchant POS system is uniquely associated with the specific purchase transaction, thus it can't be used again by the merchant or other party to create a fraudulent transaction.

Once the POS system has received the digitally signed payment request from the user, the merchant may also approve the payment request by digitally signing the payment request using his own private key. The merchant POS may then transmit the signed payment request to a remote service with which both the consumer and merchant previously registered. Using public keys to verify the signatures and identification of the consumer and merchant, as is understood by one of ordinary skill in the art of cryptography, the remote service may proceed to process and settle the purchase transaction (i.e., credit an account associated with one party and debit an account associated with the other) via proxy to a card network, payment service, etc. The payment transaction is complete and, advantageously, payment credentials associated with the consumer were not shared at the POS.

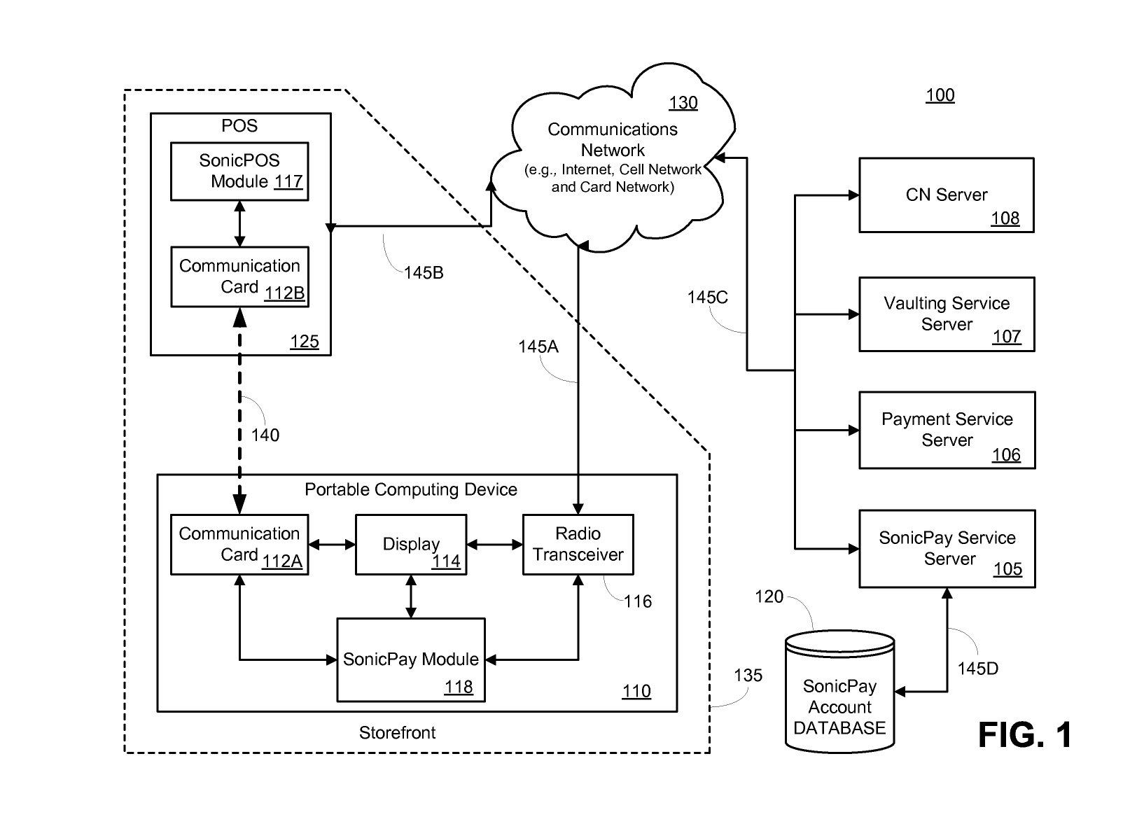

Turning now to the figures, exemplary systems and methods for completing a purchase transaction using cryptographic authorizations shared between a consumer's PCD and a merchant's POS system are described in detail. Referring to FIG. 1, depicted is a high level diagram illustrating exemplary components of a system 100 for completing a purchase transaction using cryptographic authorizations shared between a consumer's PCD 110 and a merchant's POS system 125. The illustrated components of an exemplary system 100 include PCD 110 grouped in a storefront 135 with a merchant POS terminal or register 125. It is envisioned that a merchant POS terminal or register 125 may be any component, application or system operable to receive data in payment for goods or services such as, but not limited to a cash register, a desktop computer, a laptop computer, a personal digital assistant, a tablet computer, a scanner, a cellular “smart” phone, or the like. As such, one of ordinary skill in the art will recognize that a merchant POS terminal or register may be comparable in form and function to the PCD 110 which will be described in more detail relative to subsequent figures.

Importantly, while in some embodiments storefront 135 may be a location in which a PCD 110 and POS system 125 are physically proximate, it is envisioned that other embodiments may include a virtual storefront 135 for purchase transactions, such as a website or telecommunication, wherein the PCD 110 and the POS system 125 are not physically co-located.

Leveraging system 100 to effect a purchase transaction between a consumer associated with PCD 110 and a merchant associated with POS system 125 has many useful applications. Briefly, and to provide the basis for an exemplary, non-limiting application scenario in which aspects of some embodiments of the disclosed systems and methods may be suitably described, consider a user of PCD 110 being associated with a plurality of value accounts having unique payment credentials. The plurality of value accounts are uniquely associated with the user of PCD 110 and may include any combination of credit accounts and/or stored value accounts (e.g., merchant-specific gift card accounts). To further the example, a merchant establishment, whether virtual or physical, may be represented by storefront 135.

A user/consumer associated with PCD 110 enters the merchant's store 135 with PCD 110 running a “SonicPay” module 118. The merchant's store 135 is located in an underground mall where the PCD 110 is incapable of wirelessly transmitting data online, i.e. it has no reception. The consumer presents goods for purchase to the merchant associated with POS system 125. The merchant “rings up” the goods for purchase, provides a purchase total to the consumer and asks for a payment method.

As is known to one of ordinary skill in the art, the consumer may select any number of payment methods including, but not necessarily limited to, cash, credit, gift card, debit card, etc. Notably, with the exception of payment by cash, which is essentially anonymous, each of the conventional methods of payment require the consumer to provide the merchant with confidential, or pseudo-confidential, data in the form of payment credentials. In the exemplary scenario, however, the consumer associated with PCD 110 elects payment by the “SonicPay” system and causes the PCD 110 to “listen” for a payment request from POS system 125. It should be understood that the use of the term “sonic” in connection with the exemplary systems and methods does not limit the present disclosure to the use of sound as a means for transmission of data between a PCD 110 and a POS system 125. Rather, it is envisioned that various embodiments may use other offline means of transmitting data between a PCD 110 and a POS system 125 including, but not limited to, light between photodiodes, QR codes, NFC tags, short wave radio transmissions, etc.

Returning to FIG. 1, in the exemplary scenario, the SonicPOS module 117 causes communication card 112B to transmit a payment request to the PCD 110 via wireless communication link 140. The payment request may indicate data including, but not limited to, descriptions of items presented for purchase, price totals, etc. The PCD 110 may then render the payment request on display 114 for inspection by the consumer and, if the payment request is satisfactory, the consumer may respond by entering a unique personal identification number (“PIN”) into PCD 110. Entry of the PIN will cause SonicPay module 118 to leverage communication card 112A to transmit a digital signature in the form of a cryptographically signed payment request back over link 140 to POS system 125. SonicPOS module 117 may then attach a digital signature associated with the merchant to the payment request before POS system 125 transmits the payment request and both digital signatures to SonicPay Service server 105 via a communications network 130.

The SonicPay Service server 105 may use the digital signatures to verify the identification of the merchant and consumer and query database 120 to identify accounts associated with the consumer and merchant. In some embodiments, the signed payment request may contain the consumer's payment account preference(s). The SonicPay Service server 105 may communicate with Payment Service server 106 or Vaulting Service server 107 to settle the transaction using payment credentials of the consumer, as may have been dictated by the consumer during a preregistration process or indicated by the signed payment request from the consumer. For instance, the SonicPay Service server 105 may communicate with Payment Service server 106 to debit an account associated with the consumer, such as a PayPal™ account, and credit an account associated with the merchant. Alternatively, the SonicPay Service server 105 may communicate with a Vaulting Service server 107 to cause a credit account of the consumer to be debited, such as a VISA™ or MasterCard™ account accessible via Card Network (“CN”) server 108, and an account of the merchant to be credited.

Once the digital signatures and associated purchase request data are received at SonicPay Service server 105, the digital signature of the consumer may be verified and the consumer's stored profile may be queried for associated stored value accounts in the account database 120. Notably, the value accounts associated with the consumer may be of a credit type or of a stored value account type. For the purpose of the exemplary scenario, however, suppose that a query of database 120 determines that the consumer has a gift card account associated with the merchant. In such an embodiment, SonicPay Service server 105 may leverage a predefined rules algorithm to debit the gift card account before settling the balance of the transaction to a credit account associated with Vaulting Service and CN servers 107, 108.

Concerning the various components depicted in the FIG. 1 illustration, exemplary embodiments of a PCD 110 and POS system 125 envision remote communication, real-time software updates, extended data storage, etc. Advantageously, embodiments of PCDs 110 and POS systems 125 configured for communication via a computer system such as the exemplary system 100 depicted in FIG. 1 may leverage communications networks 130 including, but not limited to cellular networks, PSTNs, cable networks, card issuer networks and the Internet for, among other things, software upgrades, content updates, database queries, registration and account configuration, data transmission, etc. Other data that may be useful in connection with a PCD 110 and/or POS system 125, and accessible via the Internet or other networked system, are understood by one of ordinary skill in the art.

The illustrated computer system 100 may comprise servers 105, 106, 107, 108 that may be coupled to a network 130 comprising any or all of a wide area network (“WAN”), a local area network (“LAN”), the Internet, or a combination of other types of networks. It should be understood that the term server may refer to a single server system or multiple systems or multiple servers. The SonicPay Service server 105 may be coupled to database 120, which may include a data/service database in addition to a user account database. The database 120 may store various records related to, but not limited to, device configurations, software updates, user's manuals, troubleshooting manuals, user-specific PCD configurations, PCD user-specific contact or account information, user-specific contact or account information, historical content, validation algorithms, cryptographic keys, filters/rules algorithms, audio/video data, etc.

When the server 105 is coupled to the network 130, the server 105 may communicate through the network 130 with various different PCDs 110 that may be comprised of desktop or laptop computers, thin clients, handheld devices such as personal digital assistants (“PDAs”), cellular telephones or other smart devices. Each PCD 110 may run or execute web browsing software or functionality to access the server 105 and its various applications at various times including, but not limited to, the initial registration process. Any device that may access the network 130 either directly or via a tether to a complimentary device may be a PCD 110 according to the computer system 100. The PCDs 110, as well as other components within system 100 such as, but not limited to, a database server (not specifically depicted) associated with data/service database 120 or POS 125, may be coupled to the network 130 by various types of communication links 145.

Each PCD 110 may include a display 114, wireless communication hardware 112, a radio transceiver 116 and a SonicPay module 118. It is envisioned that the display 114 may comprise any type of display device such as a liquid crystal display (“LCD”), a plasma display, an organic light-emitting diode (“OLED”) display, a touch activated display, and a cathode ray tube (“CRT”) display, a brail display, an LED bank, and a segmented display. A PCD 110 may execute, run or interface to a SonicPay module 118. The SonicPay module 118 may comprise a multimedia platform that may be part of a plug-in for an Internet web browser.

The SonicPay module 118 is designed to work with wireless communication hardware 112, a radio transceiver 116 and any stored or retrievable content to render a payment request and/or authorize a payment request against an account associated with a digital signature. When PCD 110 is leveraged within storefront 135, various content associated with the PCD user, purchase transaction, merchant storefront 135 and the like may be rendered on the display 114.

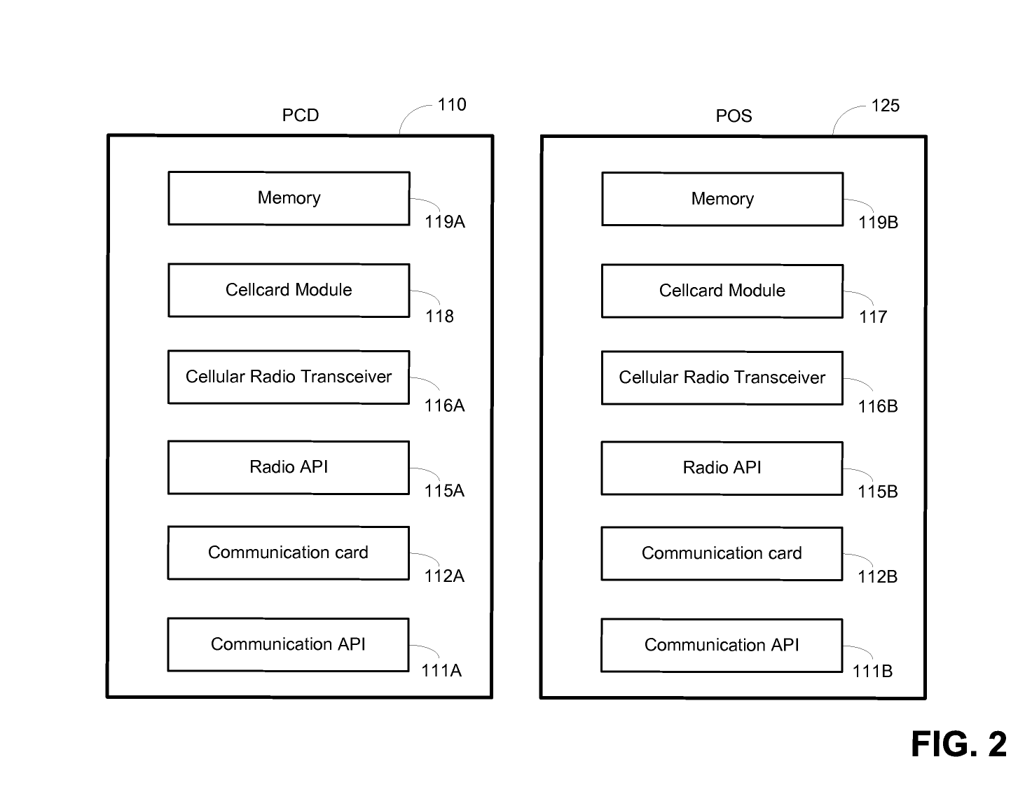

Referring to FIG. 2, an exemplary PCD 110 and/or POS system 125 may comprise wireless communication hardware 112 such as, but not limited to, a WiFi card. The PCD 110 and POS 125 may also comprise a SonicPay module 118 and a SonicPOS module 117, respectively, for transmitting and receiving payment requests, respectively, from the wireless communication hardware 112A, 112B and/or the cellular radio transceivers 116A, 116B. The SonicPay and SonicPOS modules 118, 117 may also transmit digital signatures useful for indentifying the users associated with each and verifying authorization of a certain purchase transaction, as would be understood by one of ordinary skill in the art of cryptography.

The modules 117, 118 may be configured to data through wireless communication hardware 112 via communication application programming interfaces (“API”) 111. As such, one of ordinary skill in the art will recognize that a SonicPay and/or SonicPOS module 118, 117 may be designed to include the communication API 111 and/or wireless communication hardware 112 as part of its module in a unitary design. Further, the SonicPOS module 117 may be configured to interface with cellular radio transceiver 116B, via a radio API 115B for receiving and transmitting purchase transaction authorization or confirmation data as well as other information to exemplary server 105, as depicted in the system 100 embodiment. Even further, the modules 117, 118 may be configured to leverage a text to speech (“TTS”) module (not depicted) as may be known in the art to relay non-confidential information in an audible format. Thus, one of ordinary skill in the art will also recognize that a module 117, 118 may also include the radio API 115 and/or cellular radio transceiver 116 and/or a TTS module as part of its module in a unitary design.

It is envisioned that a PCD 110 may be configured to leverage the cellular radio transceiver 116 to transmit data, such as preregistration data, a personal identification number (PIN), a security key or other data generated by SonicPay module 118 to SonicPay Service server 105 via a link 145. A wireless link 145 may comprise a secure channel established on a cellular telephone network. Moreover, communication links 145, in general, may comprise any combination of wireless and wired links including, but not limited to, any combination of radio-frequency (“RF”) links, infrared links, acoustic links, other wireless mediums, wide area networks (“WAN”), local area networks (“LAN”), the Internet, a Public Switched Telephony Network (“PSTN”), and a paging network.

An exemplary PCD 110 and/or POS system 125 may also comprise a computer readable storage/memory component 119 for storing, whether temporarily or permanently, various data including, but not limited to, purchase transaction data and digital signature data as well as data added to, extracted or derived from SonicPay related data or accounts associated with a SonicPay service user. Data added to, extracted or derived from the purchase transaction data may comprise a user ID, a transaction ID, a directory number (“DN”) or calling line ID (“CLID”) associated with PCD 110, a merchant ID, a network name, a hash value, a codec key, encryption or decryption data, account numbers and other account related data such as, but not limited to, data related to an item being purchased, price of an item being purchased, purchase discount rates or amounts, customer loyalty data, sales tax rates or amounts, merchant employee identification, etc.

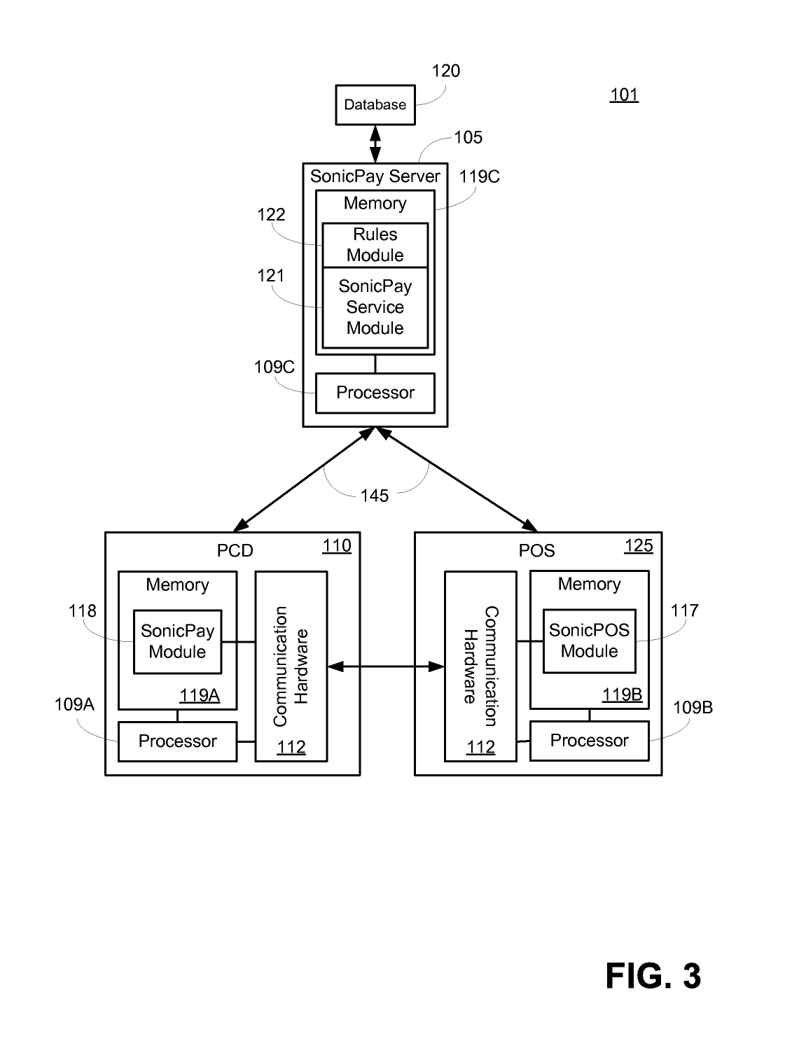

Turning now to FIG. 3, a diagram of exemplary computer architecture 101 for the system 100 of FIG. 1 is depicted. The exemplary architecture 101 may include a portable computing device (“PCD”) 110, a point of sale (“POS”) system 125 and a SonicPay Service server 105. The SonicPay Service server 105 may be connected to the PCD 110 and POS system 125 via a wireless communications link 145, such as a mobile telephone network. As noted previously, it should be understood that the term server 105 may refer to a single server system or multiple systems or multiple servers. One of ordinary skill in the art will appreciate that the various server arrangements may be selected depending upon computer architecture design constraints and without departing from the scope of the invention.

As illustrated in FIG. 3, the PCD 110, POS 125 and SonicPay server 105 may each include a processor 109 and a memory 119 coupled to the processor 109. The memory 119 may include instructions for executing one or more of the method steps described herein. Further, the processor 109 and the memory 119 may serve as a means for executing one or more of the method steps described herein. As indicated, the memory 119A may also include a SonicPay module 118, the memory 119B a SonicPOS module 117 and the memory 119C a SonicPay Service module 121 as well as a Rules module 122. The Rules module 122 may be leveraged to determine which of a plurality of stored value accounts associated with a consumer may be debited in response to a signed payment request. A SonicPay module 118 may operate to render a payment request received from POS system 125 and transmit a digital signature authorizing the payment request back to POS 125, according to various mechanisms described above relative to FIG. 1. A database 120 for storage of rules algorithms, content for dissemination, value account records, PCD user historical data, etc. may also be connected to the SonicPay Service server 105.

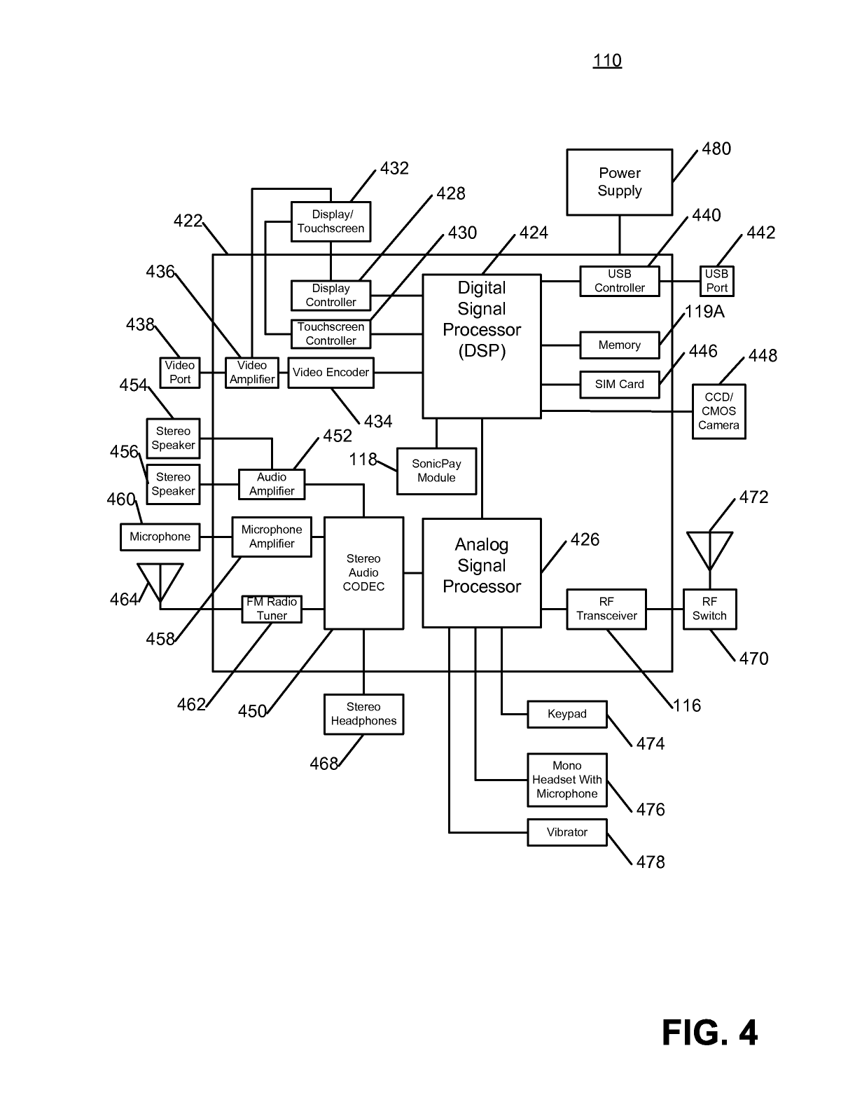

Referring to FIG. 4, this figure is a diagram of an exemplary, non-limiting aspect of a PCD 110 comprising a wireless telephone which corresponds with FIG. 2. As shown, the PCD 110 includes an on-chip system 422 that includes a digital signal processor 109A and an analog signal processor 426 that are coupled together. As illustrated in FIG. 4, a display controller 428 and a touchscreen controller 430 are coupled to the digital signal processor 109A. A touchscreen display 114 external to the on-chip system 422 is coupled to the display controller 428 and the touchscreen controller 430.

FIG. 4 further indicates that a video encoder 434, e.g., a phase-alternating line (“PAL”) encoder, a sequential couleur avec memoire (“SECAM”) encoder, a national television system(s) committee (“NTSC”) encoder or any other video encoder, is coupled to the digital signal processor 109A. Further, a video amplifier 436 is coupled to the video encoder 434 and the touchscreen display 114. A video port 438 is coupled to the video amplifier 436. A universal serial bus (“USB”) controller 440 is coupled to the digital signal processor 424. Also, a USB port 442 is coupled to the USB controller 440. A memory 119A and a subscriber identity module (“SIM”) card 446 may also be coupled to the digital signal processor 109A. Further, a digital camera 448 may be coupled to the digital signal processor 109A. In an exemplary aspect, the digital camera 448 is a charge-coupled device (“CCD”) camera or a complementary metal-oxide semiconductor (“CMOS”) camera.

As further illustrated in FIG. 4, a stereo audio CODEC 450 may be coupled to the analog signal processor 426. Moreover, an audio amplifier 452 may be coupled to the stereo audio CODEC 450. In an exemplary aspect, a first stereo speaker 454 and a second stereo speaker 456 are coupled to the audio amplifier 452 and may be used to transmit audible or ultrasonic data indicative of a digital signature to a proximate POS system 125 in response to receipt of a payment request.

FIG. 4 shows that a microphone amplifier 458 may be also coupled to the stereo audio CODEC 450. Additionally, a microphone 460 may be coupled to the microphone amplifier 458 and operable to receive an audible or ultrasonic transmission indicative of a payment request from a POS system 125. In a particular aspect, a frequency modulation (“FM”) radio tuner 462 may be coupled to the stereo audio CODEC 450. Also, an FM antenna 464 is coupled to the FM radio tuner 462. Further, stereo headphones 468 may be coupled to the stereo audio CODEC 450.

FIG. 4 further indicates that a radio frequency (“RF”) transceiver 116 may be coupled to the analog signal processor 426. An RF switch 470 may be coupled to the RF transceiver 116 and an RF antenna 472. As shown in FIG. 4, a keypad 474 may be coupled to the analog signal processor 426. Also, a mono headset with a microphone 476 may be coupled to the analog signal processor 426.

Further, a vibrator device 478 may be coupled to the analog signal processor 426. Also shown is that a power supply 480 may be coupled to the on-chip system 422. In a particular aspect, the power supply 480 is a direct current (“DC”) power supply that provides power to the various components of the PCD 110 requiring power. Further, in a particular aspect, the power supply is a rechargeable DC battery or a DC power supply that is derived from an alternating current (“AC”) to DC transformer that is connected to an AC power source.

FIG. 4 also shows that the PCD 110 may include a SonicPay module 118. The SonicPay module 118 may communicate with a SonicPOS module 117 to authorize a payment request via a digital signature.

As depicted in FIG. 4, the touchscreen display 114, the video port 438, the USB port 442, the camera 448, the first stereo speaker 454, the second stereo speaker 456, the microphone 460, the FM antenna 464, the stereo headphones 468, the RF switch 470, the RF antenna 472, the keypad 474, the mono headset 476, the vibrator 478, and the power supply 480 are external to the on-chip system 422.

In a particular aspect, one or more of the method steps described herein may be stored in the memory 119A as computer program instructions, such as SonicPay module 118. These instructions may be executed by the digital signal processor 109A, the analog signal processor 426, or another processor, to perform the methods described herein. Further, the processors, 109A, 426, the memory 119A, the instructions stored therein, or a combination thereof may serve as a means for performing one or more of the method steps described herein.

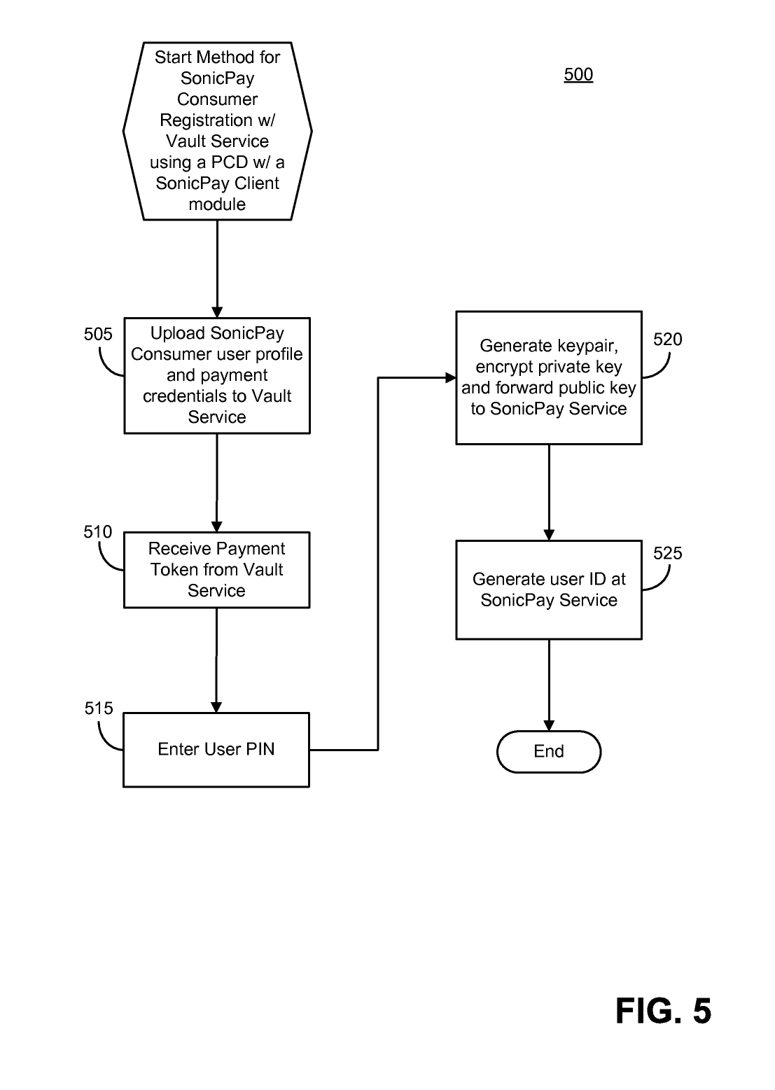

FIG. 5 is a logical flowchart illustrating an exemplary method 500 for registering, with a payment credential vault service 107, a consumer user of a system 100 for completing a purchase transaction using cryptographic authorizations shared between a consumer's PCD 110 and a merchant's POS system 125. Beginning at block 505, a consumer associated with a PCD 110 having a SonicPay client module 118 running thereon uploads a user profile and payment credentials to a vault service 107. The user profile and payment credentials represent confidential subject matter useful for routing transactions over a card network 108 to be debited against an account associated with the consumer, as is understood by one of ordinary skill in the art of card network transactions. The user profile and payment credentials may consist of, but are not limited to consisting of, the consumer's name, billing address, credit account number(s), credit card verification number(s), credit card PIN(s), password(s) and the like.

At block 510, the vault service 107 returns a token to the PCD 110 that serves to point to the uploaded user profile and payment credentials, as is understood in the art of payment credential vaulting. At block 515, a consumer associated with a PCD 110 having a SonicPay client module 118 running thereon enters a personal identification number (“PIN”) via a user interface of PCD 110, as would be understood by one of ordinary skill in the art. At block 520, the SonicPay client module 118 generates a cryptographic key pair, encrypts the private key portion of the key pair and forwards the public key portion to the SonicPay Service 105. At this point, as is understood by one of ordinary skill in the art of cryptography, the SonicPay Service 105 may use the public key to verify the identity of the consumer associated with the private key held by the SonicPay client module 118. At block 525, the SonicPay Service 105 generates a user ID for the consumer associated with PCD 110.

Notably, at the conclusion of block 525, the consumer has successfully registered with the SonicPay Service without uploading confidential payment credentials to the SonicPay service. That is, the payment credentials are safely stored at the Vaulting Service and the SonicPay service is equipped with a consumer profile, a public key for verifying a digital signature/authorization of the consumer and a token that points to the secure payment credentials at the vaulting service. The entire registration process 500 is conducted online via communication link 145A prior to a purchase transaction between the consumer associated with PCD 110 and a merchant associated with POS system 125.

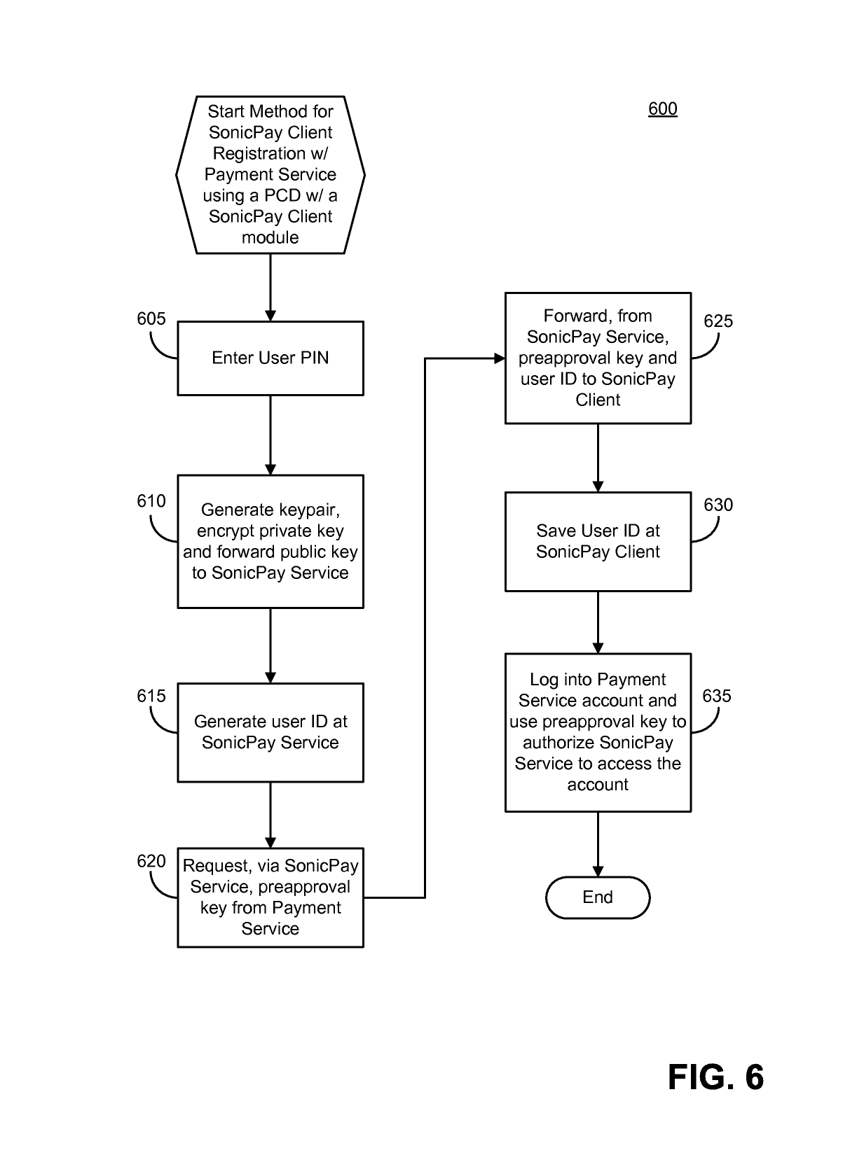

FIG. 6 is a logical flowchart illustrating an exemplary method 600 for registering, with a third party payment service 106, a consumer user of a system 100 for completing a purchase transaction using cryptographic authorizations shared between a consumer's PCD 110 and a merchant's POS system 125. Beginning at block 605, a consumer associated with a PCD 110 having a SonicPay client module 118 running thereon enters a personal identification number (“PIN”) via a user interface of PCD 110, as would be understood by one of ordinary skill in the art. At block 610, the SonicPay client module 118 generates a cryptographic key pair, encrypts the private key portion of the key pair and forwards the public key portion to the SonicPay Service 105. At this point, as is understood by one of ordinary skill in the art of cryptography, the SonicPay Service 105 may use the public key to verify the identity of the consumer associated with the private key held by the SonicPay client module 118.

At block 615, the SonicPay Service 105 generates a user ID for the consumer associated with PCD 110 and then, at block 620, requests a preapproval key from the Third Party Payment Service 106 for use in accessing a stored value account associated with the consumer of PCD 110 and managed by the Payment Service 106. Upon receiving back a preapproval key, at block 625 the SonicPay Service 105 returns the Payment Service preapproval key SonicPay Service user ID to the SonicPay client module 118 of PCD 110. At block 630, the SonicPay client module 118 saves the user ID. At block 635, the consumer of PCD 110 may log into the Payment Service 106 via communication link 145A, as is understood by one of ordinary skill in the art. Once logged in, the consumer may use the provided preapproval key to authorize the SonicPay Service 105 to have limited access to the stored value account. The registration process is complete. Notably, if provided with a digital signature and user ID associated with the consumer, the SonicPay Service 105 may use the corresponding public key to verify the identity of the consumer and facilitate authorized access to a Third Party Payment Service 106. As such, the SonicPay Service 105 may debit the stored value account on behalf of the consumer to settle a transaction authorized by the consumer.

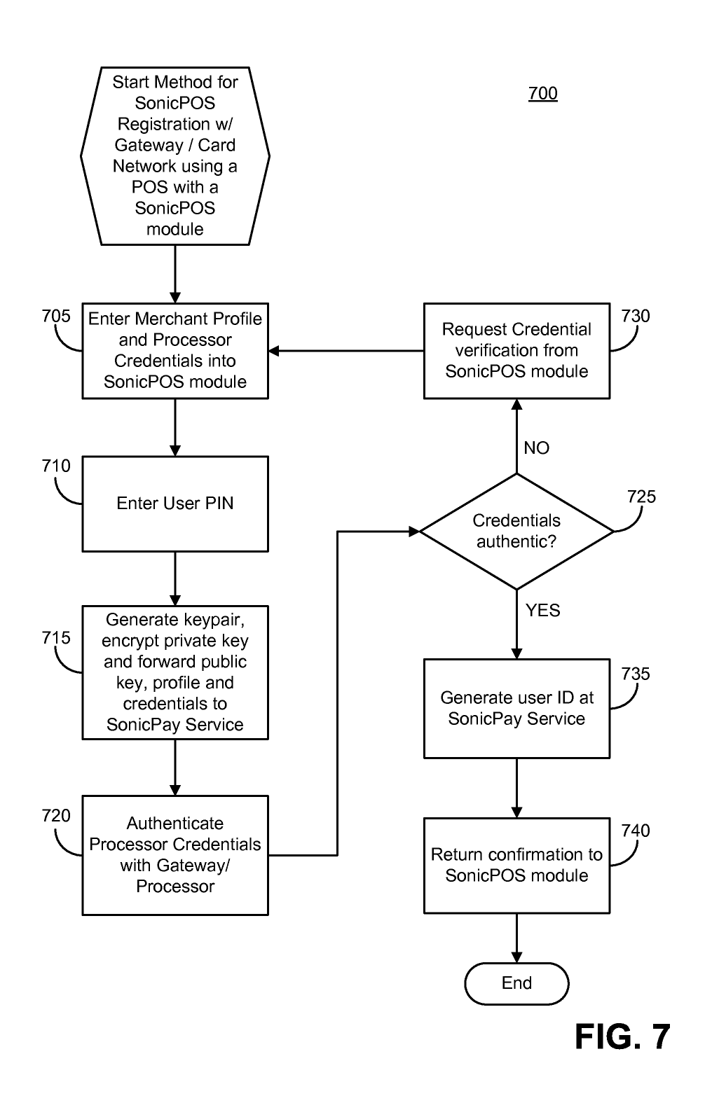

FIG. 7 is a logical flowchart illustrating an exemplary method 700 for registering the card network processor credentials of a merchant user of a system 100 for completing a purchase transaction using cryptographic authorizations shared between a consumer's PCD 110 and a merchant's POS system 125. Beginning at block 705, a merchant associated with a POS system 125 having a SonicPOS module 117 running thereon enters a profile and card network processor credentials to the SonicPOS module 117. The user profile and processor credentials may be entered via a user interface of POS system 125, as is understood by one of ordinary skill in the art. The merchant user profile and processor credentials represent confidential subject matter useful for routing transactions over a card network 108 to be credited against an account associated with the merchant, as is understood by one of ordinary skill in the art of card network transactions. The merchant user profile and processor credentials may consist of, but are not limited to consisting of, the merchant's name or identifier, address, account number(s), PIN(s), password(s) and the like.

At block 710, a merchant associated with a POS system 125 having a SonicPOS client module 117 running thereon enters a personal identification number (“PIN”) via a user interface of POS 125, as would be understood by one of ordinary skill in the art. At block 715, the SonicPOS client module 117 generates a cryptographic key pair, encrypts the private key portion of the key pair and forwards the public key portion to the SonicPay Service 105 along with the merchant profile and processor credentials. At this point, as is understood by one of ordinary skill in the art of cryptography, the SonicPay Service 105 may use the public key to verify the identity of the merchant associated with the private key held by the SonicPOS client module 117.

At block 720, the SonicPay Service 105 may use the processor credentials and profile to verify their accuracy with the gateway processor of the card network 108. At decision block 725, if the credentials fail, the process moves to block 730 where the merchant is requested to reenter or provide new credentials/profile. If the credentials are authenticated at decision block 725, then at block 735 the SonicPay Service 105 generates a user ID for the merchant associated with POS system 125. At block 740 a confirmation including the user ID may be returned to the merchant POS system 125 indicating that registration is complete.

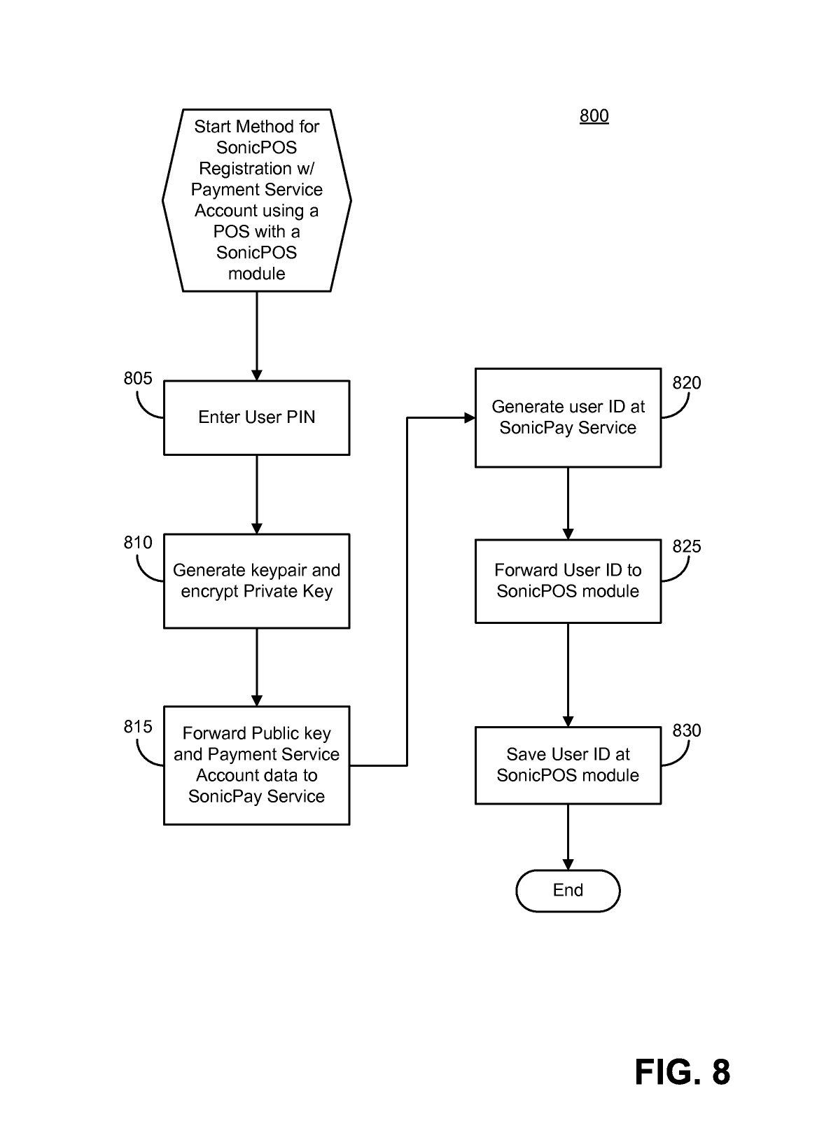

FIG. 8 is a logical flowchart illustrating an exemplary method 800 for registering a third party payment service account of a merchant user of a system 100 for completing a purchase transaction using cryptographic authorizations shared between a consumer's PCD 110 and a merchant's POS system 125. Beginning at block 805, a merchant associated with a POS system 125 having a SonicPOS module 117 running thereon enters a PIN via a user interface of POS system 125, as would be understood by one of ordinary skill in the art. At block 810, the SonicPOS module 117 generates a public/private key pair, as is understood by one of ordinary skill in the art of cryptography. At block 815, the POS system 125 transmits the public key portion of the key pair and payment service account data to the SonicPay System 105. Notably, with the public key the SonicPay System 105 may readily verify a digital signature of the merchant that includes the private key generated at block 810. At block 820, the SonicPay System 105 generates a user ID in association with the merchant profile, account data and key and, at block 825, forwards the ID to the merchant POS system 125. Having received the ID at the POS system 125, the SonicPOS module 117 saves the ID which may be used later to point the SonicPay System 105 to the various account and key data associated with the merchant. Notably, with the merchant account data of the payment service 106, the SonicPay System 105 may credit the merchant account to settle a transaction on behalf of the merchant.

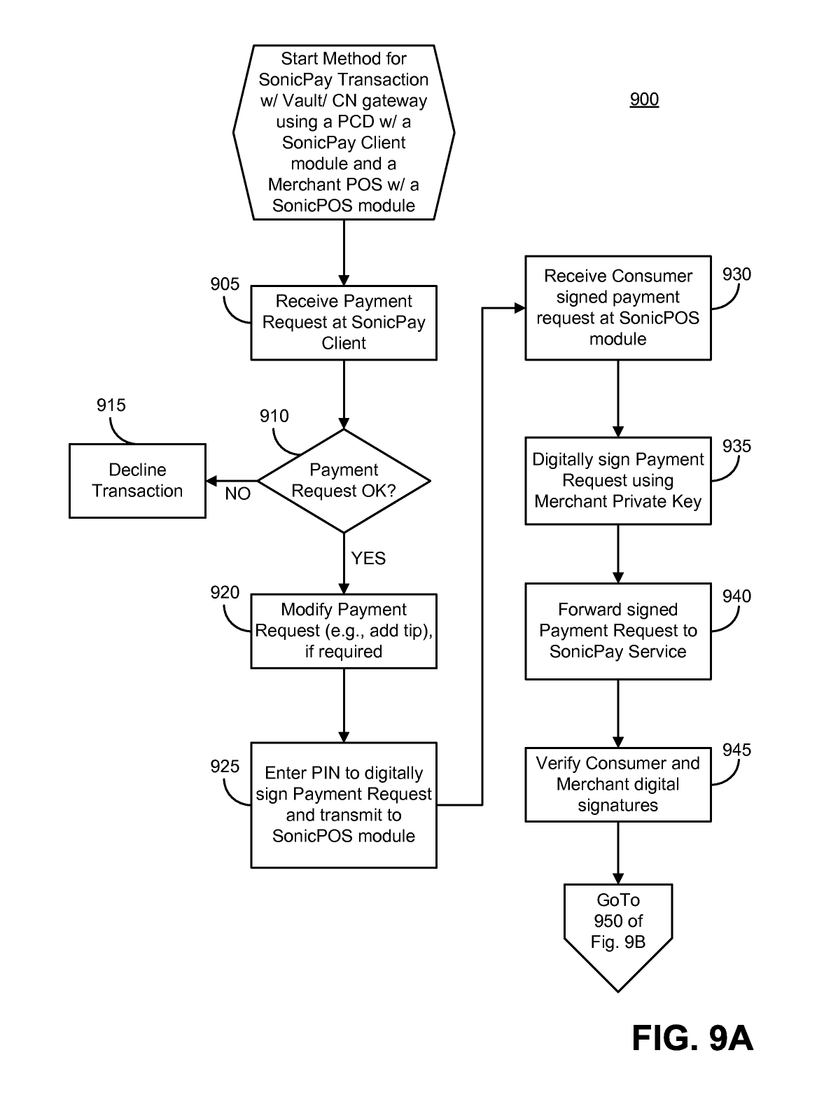

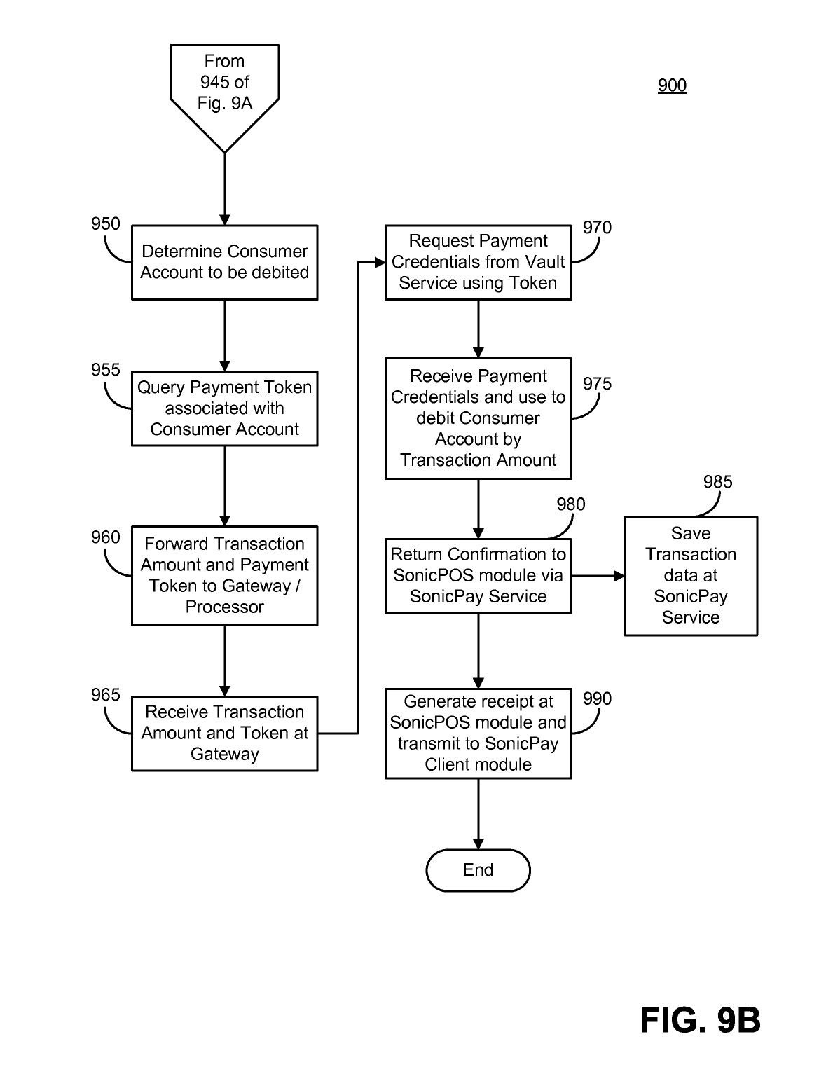

FIG. 9A-9B is a logical flowchart illustrating an exemplary method 900 for completing a purchase transaction through a card network processor 108 using cryptographic authorizations shared between a consumer's PCD 110 and a merchant's POS system 125. Prior to beginning the method 900, both the consumer associated with PCD 110 and the merchant associated with POS system 125 will have completed the registration process per the exemplary methods outlined and described relative to FIGS. 5 and 7, respectively. At block 905, the consumer PCD 110 and merchant POS system 125 are physically proximate in storefront 135. Notably, it will be understood that the term storefront is meant only to indicate that the PCD 110 and POS system 125 are physically proximate to one another and is not meant to limit the environment of a storefront in any way. That is, it will be understood that a storefront may be any locale physically or virtually common to both a PCD 110 and POS system 125. For example, certain embodiments may be operable to conduct purchase transactions in a mobile environment wherein neither the PCD 110 nor the POS system 125 is stationary. Further, it is also envisioned that certain embodiments, such as embodiments that rely on sound based communications between a PCD 110 and a POS system 125, may conduct purchase transactions over a telecommunication link using the methodologies and their equivalents described herein.

Returning to method 900, at block 905 the consumer PCD 110 receives a payment request transmitted from POS system 125. The payment request, at its essence, is an invoice or the like for a good or service that the consumer wishes to purchase from the merchant associated with POS system 125. For example, the consumer may have placed an item priced at $9.99 on the merchant's counter with the intent to purchase the item. The merchant then may have “rung up” the item, thereby adding tax for a total price of $10.50. The payment request, in the example, would indicate the total price of $10.50—the merchant is asking the consumer to remit $10.50 in order to purchase the item. Moreover, as described above, the payment request may be transmitted wirelessly from the POS system 125 to the PCD 110 via any number of ways including, but not limited to, sound, light, radio transmission, etc. In certain embodiments, the POS system 125 and the PCD 110 are equipped with microphones and speakers that are configured to transmit and receive data via sound. In some such embodiments, the sound may be audible to the users of the PCD 110 and POS system 125, although not all embodiments require that the sound frequency be audible to the users. For instance, in some embodiments, the sound may be at a frequency that attenuates quickly so not as to interfere with other transactions occurring nearby. Further, some embodiments, the data may be transmitted between a POS system 125 and a PCD 110 at a frequency inaudible to the users while an audible tone is used to notify the users of the process.

Returning to the method 900, at decision block 910 the consumer associated with PCD 110 may review the payment request and determine if it is satisfactory. In the example above, if the $10.50 price for the item was not acceptable to the consumer, then the consumer may decline the purchase at block 915. In some embodiments, declining the purchase may cause PCD 110 to return a signal to POS system 125 indicating that the consumer has declined the transaction, although such is not required in all embodiments. If at decision block 910 the consumer approves the payment request, then in some embodiments the consumer may modify the payment request at block 920 such as add a tip, make a counter offer, etc.

Once the payment request is in condition for approval by the consumer, at block 925 the consumer may enter a PIN which causes the PCD 110 to digitally sign the payment request. As described above, the digital signature is generated using a unique private key associated with the user and serves to indicate the consumer's identity to a holder of the complimentary public key. The signed payment request is transmitted back to the POS system 125 and received at block 930. At block 935, the SonicPOS module 117 may add the digital signature of the merchant to the payment request and the consumer digital signature at block 935. At block 940, the bundle of the payment request and the unique digital signatures are forwarded from the SonicPOS system 125 to the SonicPay Service 105.

Upon receiving the digital signatures of the transacting parties (the merchant and the consumer) which indicate approval of the payment request, at block 945 the SonicPay Service 105 may use the public keys uploaded in exemplary registration methods 500 and 700 to verify the identity of the transacting parties. At block 950, the SonicPay Service may determine from the user's profile or the signed payment request that a certain one (or more) of a plurality of accounts associated with the consumer should be debited in accordance with the payment request total. It is envisioned, however, that some embodiments of a SonicPay Service may include a Rules module 122 for selecting consumer accounts according to predefined rules or algorithms. For instance, a Rules module 122 may be configured to select consumer accounts to maximize rewards points, take advantage of pre-loaded gift accounts, etc.

Returning to the method 900 at block 955, the SonicPay Service 105, having identified the consumer via the digital signature, may query database 120 to identify a token that points to a previously registered payment account of the consumer. At block 960, the SonicPay Service 105 leverages the token to settle the transaction to the identified consumer account by forwarding the token and payment request to a gateway/card processor as is understood in the art of card network transactions. At block 965, the token and settlement transaction are received at the gateway processor 108 and, at block 970, the processor uses the token to request the associated payment credentials from the vault service 107.

At block 975, the gateway 108 receives the payment credentials from the vault service 107 and uses the credentials to debit the associated account by the amount of the payment request. In some embodiments, at block 980 a confirmation that the transaction has been settled to the consumer account is returned to the POS system 125 via communication links of network 130. The SonicPay Service may save data representative of the transaction at block 985 so that the consumer may access it at a later date. At block 990, the SonicPOS module 117 may generate a receipt and wirelessly transmit such to the PCD 110 of the user where the SonicPay module 118 may cause the receipt to be rendered on the display of the PCD 110.

Advantageously, a purchase transaction completed via exemplary method 900 occurs without the consumer PCD 110 being online. That is, the data transmitted from PCD 110 and received by PCD 110 during the process is exchanged entirely within storefront 135 wirelessly from PCD 110 and POS system 125. Further, the purchase transaction occurs without the need for confidential payment credentials of the consumer to be stored on the PCD 110 or, for that matter, transmitted from PCD 110 to merchant POS system 125.

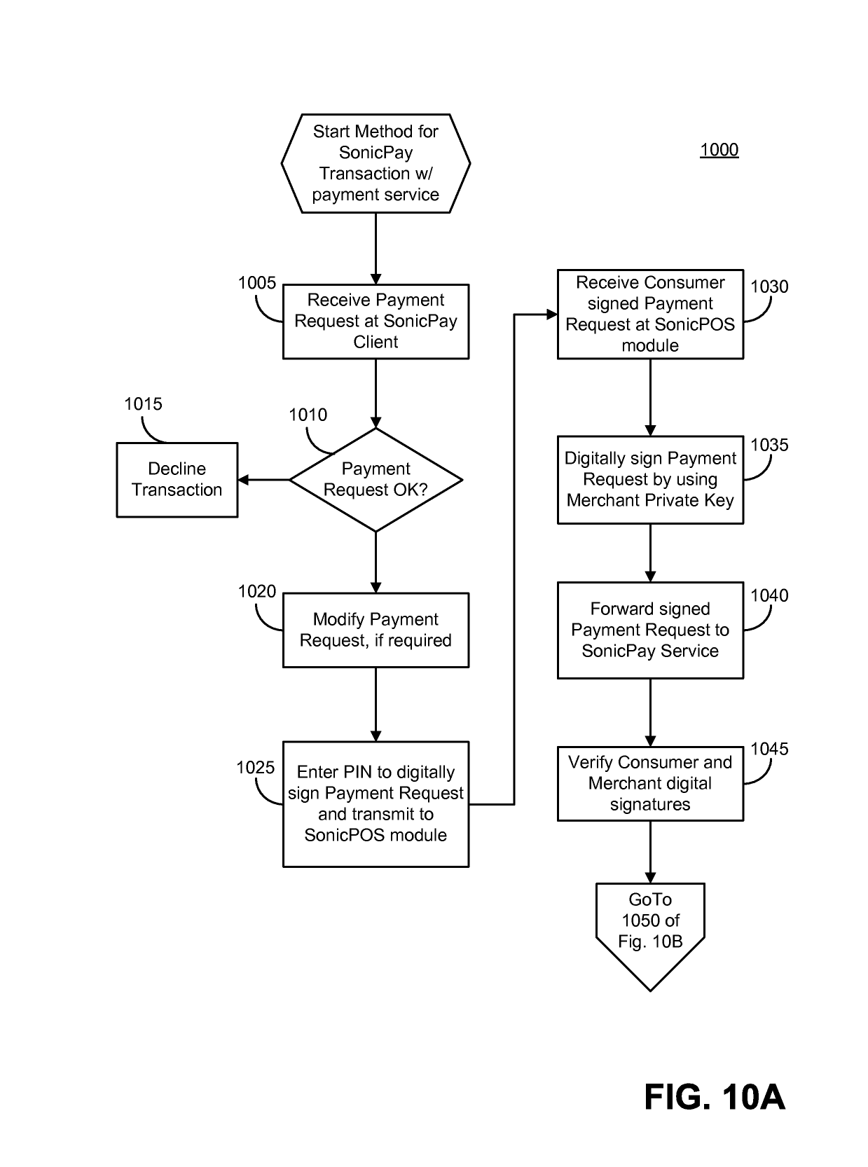

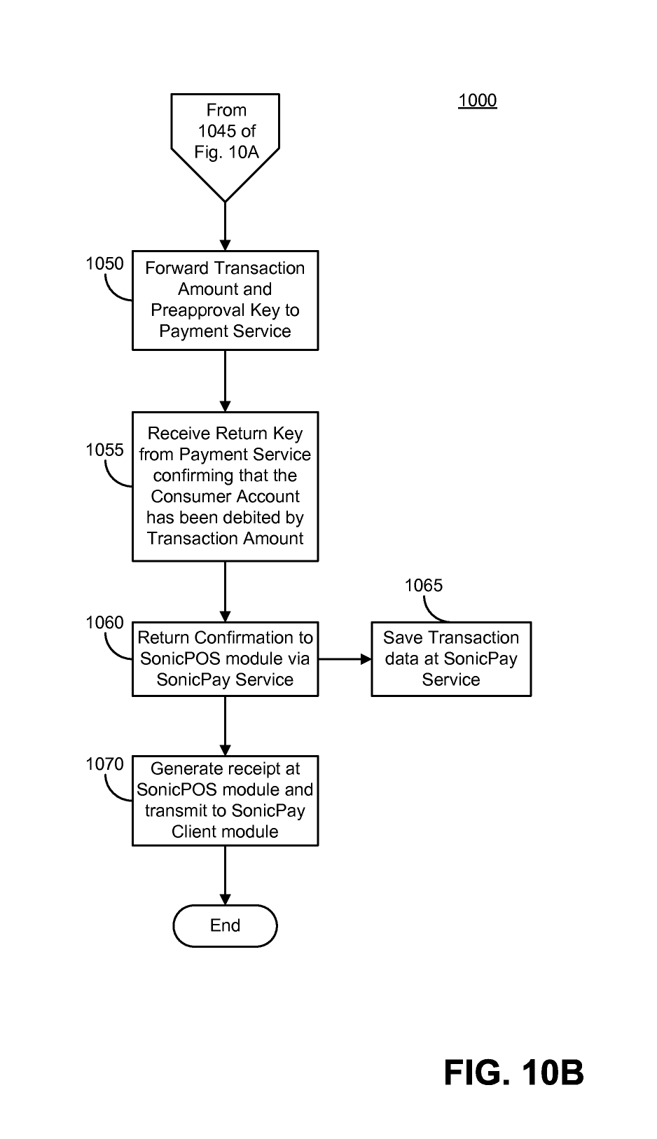

FIG. 10A-10B is a logical flowchart illustrating an exemplary method 1000 for completing a purchase transaction through a third party payment service 106 account using cryptographic authorizations shared between a consumer's PCD 110 and a merchant's POS system 125. Blocks 1005 through 1045 (FIG. 10A) of method 1000 correlate with blocks 905-945 (FIG. 9A) of method 900. At block 1050, however, method 1000 differs from method 900. At block 1050, the SonicPay Service 105 forwards the transaction amount associated with the payment request, along with the preapproval key received during the registration process of FIG. 8, to the payment service 106. At block 1055, a return key is received from the payment service indicating that the transaction amount has been credited to the merchant account. At block 1060, a confirmation may be returned to the SonicPOS system 125 and transaction data saved by the SonicPay Service 105 for later query by the merchant. At block 1070, a receipt for the purchase transaction may be generated by the POS system 125 and wirelessly transmitted to the PCD 110, similar to that which has been described relative to block 990 of method 900.

Advantageously, a purchase transaction completed via exemplary method 1000 occurs without the consumer PCD 110 being online. That is, the data transmitted from PCD 110 and received by PCD 110 during the process is exchanged entirely within storefront 135 wirelessly between PCD 110 and POS system 125. Further, the purchase transaction occurs without the need for confidential payment credentials of the consumer to be stored on the PCD 110 or, for that matter, transmitted from PCD 110 to merchant POS system 125.

Certain steps or blocks in the processes or process flows described in this specification naturally precede others for the invention to function as described. However, the invention is not limited to the order of the steps or blocks described if such order or sequence does not alter the functionality of the invention. That is, it is recognized that some steps or blocks may performed before, after, or parallel (substantially simultaneously with) other steps or blocks without departing from the scope and spirit of the invention. In some instances, certain steps or blocks may be omitted or not performed without departing from the invention. Also, in some instances, multiple actions depicted and described as unique steps or blocks in the present disclosure may be comprised within a single step or block. Further, words such as “thereafter”, “then”, “next”, “subsequently”, etc. are not intended to limit the order of the steps or blocks. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another.

A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, acoustic and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for completing a purchase transaction via digital signature of a payment request, the method comprising:
generating a payment request at a point of sale (“POS”) system associated with a merchant, wherein the payment request comprises a transaction amount;
transmitting the payment request from the POS system;
receiving a first digital signature approving the payment request;
generating a second digital signature approving the payment request; and
completing the purchase transaction by transmitting the payment request and data indicating the first and second digital signatures, wherein completion of the purchase transaction causes an account associated with the merchant to be credited by the transaction amount.

2. The method of claim 1, wherein the payment request and first digital signature are transmitted via sound.

3. The method of claim 1, wherein the payment request and first digital signature are transmitted via a near field communication (“NFC”) standard.

4. The method of claim 1, wherein the first digital signature is generated using a private key uniquely associated with a consumer.

5. The method of claim 1, wherein the second digital signature is generated using a private key uniquely associated with the merchant.

6. The method of claim 1, wherein the first and second digital signatures are verifiable via use of corresponding public keys.

7. The method of claim 1, wherein the account associated with the merchant is credited by debiting an account associated with a consumer.

8. The method of claim 1, wherein the account associated with the merchant is credited from a stored value account associated with a third party payment service.

9. The method of claim 1, further comprising generating a receipt indicating that the purchase transaction has been completed.

10. The method of claim 9, further comprising transmitting the receipt.

11. A system for completing a purchase transaction via digital signature of a payment request, the system comprising:
a point of sale (“POS”) system associated with a merchant for:
generating a payment request, wherein the payment request comprises a transaction amount;
transmitting the payment request;
receiving a first digital signature approving the payment request;
generating a second digital signature approving the payment request; and
completing the purchase transaction by transmitting the payment request and data indicating the first and second digital signatures, wherein completion of the purchase transaction causes an account associated with the merchant to be credited by the transaction amount.

12. The system of claim 11, wherein the payment request and first digital signature are transmitted via sound.

13. The system of claim 11, wherein the payment request and first digital signature are transmitted via a near field communication (“NFC”) standard.

14. The system of claim 11, wherein the first digital signature is generated using a private key uniquely associated with a consumer.

15. The system of claim 11, wherein the second digital signature is generated using a private key uniquely associated with the merchant.

16. The system of claim 11, wherein the first and second digital signatures are verifiable via use of corresponding public keys.

17. The system of claim 11, wherein the account associated with the merchant is credited by debiting an account associated with a consumer.

18. The system of claim 11, wherein the account associated with the merchant is credited from a stored value account associated with a third party payment service.

19. The system of claim 11, further comprising generating a receipt indicating that the purchase transaction has been completed.

20. The system of claim 19, further comprising transmitting the receipt.

21. A system for completing a purchase transaction via digital signature of a payment request, the system comprising:
means for generating a payment request at a point of sale (“POS”) system associated with a merchant, wherein the payment request comprises a transaction amount;
means for transmitting the payment request from the POS system;
means for receiving a first digital signature approving the payment request;
means for generating a second digital signature approving the payment request; and
means for completing the purchase transaction by transmitting the payment request and data indicating the first and second digital signatures, wherein completion of the purchase transaction causes an account associated with the merchant to be credited by the transaction amount.

22. The system of claim 21, wherein the payment request and first digital signature are transmitted via sound.

23. The system of claim 21, wherein the payment request and first digital signature are transmitted via a near field communication (“NFC”) standard.

24. The system of claim 21, wherein the first digital signature is generated using a private key uniquely associated with a consumer.

25. The system of claim 21, wherein the second digital signature is generated using a private key uniquely associated with the merchant.

26. The system of claim 21, wherein the first and second digital signatures are verifiable via use of corresponding public keys.

27. The system of claim 21, wherein the account associated with the merchant is credited by debiting an account associated with a consumer.

28. The system of claim 21, wherein the account associated with the merchant is credited from a stored value account associated with a third party payment service.

29. The system of claim 21, further comprising means for generating a receipt indicating that the purchase transaction has been completed.

30. The system of claim 29, further comprising means for transmitting the receipt.

31. A computer program product comprising a computer usable medium having a computer readable program code embodied therein, said computer readable program code executable to implement a method for completing a purchase transaction via digital signature of a payment request, the method comprising:
generating a payment request at a point of sale (“POS”) system associated with a merchant, wherein the payment request comprises a transaction amount;
transmitting the payment request from the POS system;
receiving a first digital signature approving the payment request;
generating a second digital signature approving the payment request; and
completing the purchase transaction by transmitting the payment request and data indicating the first and second digital signatures, wherein completion of the purchase transaction causes an account associated with the merchant to be credited by the transaction amount.

32. The computer program product of claim 31, wherein the payment request and first digital signature are transmitted via sound.

33. The computer program product of claim 31, wherein the payment request and first digital signature are transmitted via a near field communication (“NFC”) standard.

34. The computer program product of claim 31, wherein the first digital signature is generated using a private key uniquely associated with a consumer.

35. The computer program product of claim 31, wherein the second digital signature is generated using a private key uniquely associated with the merchant.

36. The computer program product of claim 31, wherein the first and second digital signatures are verifiable via use of corresponding public keys.

37. The computer program product of claim 31, wherein the account associated with the merchant is credited by debiting an account associated with a consumer.

38. The computer program product of claim 31, wherein the account associated with the merchant is credited from a stored value account associated with a third party payment service.

39. The computer program product of claim 31, further comprising generating a receipt indicating that the purchase transaction has been completed.

40. The computer program product of claim 39, further comprising transmitting the receipt.

41. A method for completing a purchase transaction via digital signature of a payment request, the method comprising:
receiving a payment request at a portable computing device (“PCD”) associated with a consumer, wherein the payment request comprises a transaction amount;
generating a digital signature approving the payment request; and
completing the purchase transaction by transmitting the payment request and data indicating the digital signature from the PCD, wherein completion of the purchase transaction causes an account associated with the consumer to be debited by the transaction amount.

42. The method of claim 41, wherein the payment request and digital signature are transmitted via sound.

43. The method of claim 41, wherein the payment request and digital signature are transmitted via a near field communication (“NFC”) standard.

44. The method of claim 41, wherein the digital signature is generated using a private key uniquely associated with the consumer.

45. The method of claim 41, wherein the digital signature is verifiable via use of a corresponding public key.

46. The method of claim 41, wherein the account associated with the consumer is debited by crediting an account associated with a merchant.

47. The method of claim 41, wherein the account associated with the consumer is a stored value account associated with a third party payment service.

48. The method of claim 41, further comprising receiving a receipt indicating that the purchase transaction has been completed.

49. The method of claim 48, further comprising rendering the receipt.

50. The method of claim 41, wherein the PCD is a cellular telephone.

51. A system for completing a purchase transaction via digital signature of a payment request, the system comprising:
a portable computing device (“PCD”) associated with a consumer for:
receiving a payment request, wherein the payment request comprises a transaction amount;
generating a digital signature approving the payment request; and
completing the purchase transaction by transmitting the payment request and data indicating the digital signature from the PCD, wherein completion of the purchase transaction causes an account associated with the consumer to be debited by the transaction amount.

52. The system of claim 51, wherein the payment request and digital signature are transmitted via sound.

53. The system of claim 51, wherein the payment request and digital signature are transmitted via a near field communication (“NFC”) standard.

54. The system of claim 51, wherein the digital signature is generated using a private key uniquely associated with the consumer.

55. The system of claim 51, wherein the digital signature is verifiable via use of a corresponding public key.

56. The system of claim 51, wherein the account associated with the consumer is debited by crediting an account associated with a merchant.

57. The system of claim 51, wherein the account associated with the consumer is a stored value account associated with a third party payment service.

58. The system of claim 51, further comprising receiving a receipt indicating that the purchase transaction has been completed.

59. The system of claim 58, further comprising rendering the receipt.

60. The system of claim 51, wherein the PCD is a cellular telephone.

61. A system for completing a purchase transaction via digital signature of a payment request, the system comprising:
means for receiving a payment request at a portable computing device (“PCD”) associated with a consumer, wherein the payment request comprises a transaction amount;
means for generating a digital signature approving the payment request; and
means for completing the purchase transaction by transmitting the payment request and data indicating the digital signature from the PCD, wherein completion of the purchase transaction causes an account associated with the consumer to be debited by the transaction amount.

62. The system of claim 61, wherein the payment request and digital signature are transmitted via sound.

63. The system of claim 61, wherein the payment request and digital signature are transmitted via a near field communication (“NFC”) standard.

64. The system of claim 61, wherein the digital signature is generated using a private key uniquely associated with the consumer.

65. The system of claim 61, wherein the digital signature is verifiable via use of a corresponding public key.

66. The system of claim 61, wherein the account associated with the consumer is debited by crediting an account associated with a merchant.

67. The system of claim 61, wherein the account associated with the consumer is a stored value account associated with a third party payment service.

68. The system of claim 61, further comprising means for receiving a receipt indicating that the purchase transaction has been completed.

69. The system of claim 68, further comprising means for rendering the receipt.

70. The system of claim 61, wherein the PCD is a cellular telephone.

71. A computer program product comprising a computer usable medium having a computer readable program code embodied therein, said computer readable program code executable to implement a method for completing a purchase transaction via digital signature of a payment request, the method comprising:
receiving a payment request at a portable computing device (“PCD”) associated with a consumer, wherein the payment request comprises a transaction amount;
generating a digital signature approving the payment request; and
completing the purchase transaction by transmitting the payment request and data indicating the digital signature from the PCD, wherein completion of the purchase transaction causes an account associated with the consumer to be debited by the transaction amount.

72. The computer program product of claim 71, wherein the payment request and digital signature are transmitted via sound.

73. The computer program product of claim 71, wherein the payment request and digital signature are transmitted via a near field communication (“NFC”) standard.

74. The computer program product of claim 71, wherein the digital signature is generated using a private key uniquely associated with the consumer.

75. The computer program product of claim 71, wherein the digital signature is verifiable via use of a corresponding public key.

76. The computer program product of claim 71, wherein the account associated with the consumer is debited by crediting an account associated with a merchant.

77. The computer program product of claim 71, wherein the account associated with the consumer is a stored value account associated with a third party payment service.

78. The computer program product of claim 71, further comprising receiving a receipt indicating that the purchase transaction has been completed.

79. The computer program product of claim 78, further comprising rendering the receipt.

80. The computer program product of claim 71, wherein the PCD is a cellular telephone.
